(19) United States
(12) Patent Application Publication
(10) Pub. No.: US 2011/0116674 A1
(43) Pub. Date: May 19, 2011

(54) HEADPHONE

(75) Inventors: Michihito Asakura, Tendo-shi (JP); Oriaki Nihei, Tendo-shi (JP)

(73) Assignees: PIONEER CORPORATION, Kawasaki-shi, Kanagawa (JP); TOHOKU PIONEER CORPORATION, Tendo-shi, Yamagata (JP)

(21) Appl. No.: 12/933,394

(22) PCT Filed: Oct. 2, 2008
(86) PCT No.: PCT/JP2008/067898

§ 371 Date: Dec. 6, 2010

(51) Int. Cl. H04R 1/10

(52) U.S. Cl. 381/378

(57) ABSTRACT

A headphone capable of preventing inadvertent damage is disclosed. The headphone includes a C-shaped headband, a strip-shaped arm portion, a sound emitting portion supported by the arm portion, a first connecting section, and a torsion-coil spring 16. The first connecting section connects the arm portion 3 to the headband 2 rotatably about a first axis parallel to a direction from the headband 2 toward the arm portion 3. The torsion-coil spring 16 is constructed to bias the arm portion 3, when the arm portion 3 is rotated about the first axis P1, toward a neutral position in which the arm portion 3 becomes parallel to the headband 2.

### TECHNICAL FIELD

The present invention in general relates to a headphone used in an over-the-head fashion.

### BACKGROUND ART

Various headphones have been conventionally used as an over-the-head-type headphone (for example, see the patent literature PTL 1). The headphone of the patent literature PTL 1 has a pair of sound emitting portions each accommodating a speaker unit reproducing a sound; a bridge-like shaped hanger supporting the sound emitting portions; a headband for being hanged over the head of a user, and a rotation supporting portion supporting the hanger rotatably with respect to the headband.

In the above mentioned headphone, the rotation supporting portion directs the sound emitting portions in a given position such that the sound emitting portions are in close contact with the user's head and the sound reproduced by the speaker unit is guided to the user's ear (see the patent literature 1: Japanese Utility Model Publication No. S63-020233).

### SUMMARY OF THE INVENTION

### Technical Problem

In a headphone disclosed in the patent literature 1, sound emitting portions are provided rotatably at a rotation supporting portion without being spring-biased. Therefore, the orientation of the sound emitting portion is liable to vary with respect to the headband.

Therefore, the sound emitting portion was easy to exceed allowable rotation range of the rotation supporting portion, and the rotation supporting portion and the hanger was easy to be damaged inadvertently.

The present invention is intended to solve these problems.

An object of the present invention, for example, is to provide a headphone that is capable of preventing inadvertent damage of the headphone.

### Solution to Problem

In order to solve the above-mentioned problems and attain the above-identified objects. there is provided a headphone that includes a headband; a strip-shaped arm portion; a sound emitting portion supported by the arm portion; a first connecting section connecting the arm portion to the headband such that the arm portion is rotatable about a first axis parallel to the direction from the headband toward the arm portion; and a biasing element biasing the arm portion toward the neutral position relative to the headband when the arm portion is rotated about the first axis.

### BRIEF DESCRIPTION OF THE DRAWINGS

FIG. 1 is a perspective rear view of a headphone according to one embodiment of the present invention;

FIG. 2 is a perspective view of components including a first connecting section, a second connecting section, and a retention structure that are viewed from the back side of the section II in FIG. 1;

FIG. 3 is an exploded perspective view of the components including the first and second connecting sections and the retention structure shown in FIG. 2;

FIG. 4 is another exploded perspective view of the components including the first and second connecting section and the retention structure shown in FIG. 2;

FIG. 5 is an exploded perspective view of the components including the retention structure shown in FIG. 4;

FIG. 6 is an exploded perspective view of components including a third connecting section and a second retention structure of the headphone device shown in FIG. 1;

FIG. 7 is an exploded perspective view illustrating the principal feature of the third connecting section and the second retention structure shown in FIG. 6;

FIG. 8 is a cross-sectional view of the principal features of the third connecting section and the second retention structure shown in FIG. 6;

FIG. 9 is a perspective view for illustration of a state in which a torsion-coil spring shown in FIG. 3 urges an arm portion in a neutral position;

FIG. 10 is a perspective view for illustration of a state in which the torsion-coil spring shown in FIG. 3 biases the arm portion toward the neutral position;

FIG. 11 is a cross-sectional view of the components including the retention structure shown in FIG. 4;

FIG. 12 is a cross-sectional view of a sound emission portion shown in FIG. 11 in its folded state;

FIG. 13 is a cross-sectional view of the principal features of a derivative configuration of the third connecting section and the second retention structure shown in FIG. 8;

FIG. 14 is an exploded perspective view of the principal features of derivative configuration of the third connecting section and the second retention structure shown in FIG. 7;

FIG. 15 is a perspective view of the components including the connecting hole of the first connecting section shown in FIG. 12;

FIG. 16 is another perspective view of the components including a connecting hole of the first connecting section shown in FIG. 15;

FIG. 17 is another exploded perspective view of the components including the third connecting section and the second retention structure of the headphone device shown in FIG. 1;

FIG. 18 is a perspective view of the principal features of the third connecting section and the second retention structure shown in FIG. 6;

FIG. 19 is a perspective view showing the principal part of the third connecting section and the second retention structure shown in FIG. 18 in a cross section;

FIG. 20 is a perspective view of an ear pad of the headphone according to one embodiment of the present invention; and

FIG. 21 is a cross-sectional enlarged view of an ear pad of the section XXI in FIG. 20.

### REFERENCE NUMERALS

1 Headphone
2 Headband
3 Arm portion
4 Sound emitting portion
5 First connecting section
6 Second connecting section
7 Third connecting section
12 First connection member
16 Torsion-coil spring (biasing element)
22 Elastically-deformable member
23 Bar-shaped portion
24 Second connection member
25 Notch
27 Shaft
28 Connection member
30 Retention structure (second holding element)
32 Round concave portion (fitting counter part)
34 Protrusive plate (fitting member)
35 Coil spring (first biasing member)
40 Accommodating portion
42 Slide-connecting shaft (accommodating counter portion)
48 Second retention structure (third holding element)
49 straightly convex portion (convex portion)
50 straightly concave portion (concave portion)
51 Coil spring (second biasing member)
52 Back face (inner face)
58 End face
P1 First axis
P2 Second axis
P3 Third axis

### DESCRIPTION OF THE EMBODIMENT

One embodiment of the present invention will be explained below. The headphone of the one embodiment of the present invention includes a biasing element. The biasing element is adapted to bias an arm portion of the headphone toward a neutral position of the arm portion when the arm portion supporting a sound emitting portion is rotated with respect to a headband.

This construction allows a user to listen to a reproduced sound coming from a speaker, with the sound emitting portion being in contact with the ear of the user as well as outside sound, with the sound emitting portion directed to the opposite direction with respect to the user's ear. Further, this construction allows the user to listen again to the reproduced sound with the arm portion restored to the neutral position by virtue of a biasing force exerted by the biasing element.

Thus, when the sound emitting portion is in use, the arm portion is kept in the neutral position. When the sound emitting portion is not in use, the sound emitting portion is kept to be rotated and directed in a desired direction. Further, when the headphone is carried, the sound emitting portion is protected from being rotated wigglingly with respect to the headband and producing strange noise. Further, since the arm portion namely the sound emitting portion can be placed in the neutral position, the arm portion is prevented from being taken out of the allowable rotation range of a first connecting section, so as to prevent inadvertent damage to the first connecting section.

In addition, the biasing element of the present invention may include a ring-shaped elastically-deformable member and a pair of rod-shaped portions, with one of the rod-shaped portions connected to the arm portion, and the other one of the rod-shaped portions connected to the headband. Thus the biasing element permits the arm portion to bias toward the neutral position.

Further, in addition to the first connecting section, there may be provided a second connecting section rotatably to connect the arm portion to the first connecting section about a second axis orthogonal to a first axis. In this case, the sound emitting portion can be folded in such a manner that the sound emitting portion is in contact with the headband.

Also, there may be provided a connection member integrally formed of a first connecting member constructing first connection section and a second connection member constructing the second connecting section. In this case, even when there is provided the second connecting section in addition to the first connecting section, increase in the member of components can be restrained.

Further, the first connection member may have a tubular shape accommodating the biasing element, and the second connection member may have a tubular shape accommodating a shaft. In this case, it can be prevented to become the headphone larger even when the second connecting portion is provided in addition to the first connecting portion.

Also, a second holding element may be provided to maintain relative positions of the first connecting section and the arm portion around the second axis. In this case, even when the second connecting portion is provided in addition to the first connecting portion, the sound emitting portion is prevented from being rotated wigglingly with respect to the headband, and strange noise an be prevented from generating when the headphone is carried by the user. Also, the arm portion is prevented from being taken out of the allowable rotation range of the second connecting portion, and inadvertent fracture of the second connecting portion can be prevented.

Further, the second holding element may include fitting counterparts, a fitting member and a first biasing member. The fitting counterparts are provided on an outer peripheral surface of the second connection member circumferentially spaced from each other. The fitting member is capable of protruding and retracting from the arm portion and can fit with the fitting counter portion. The first biasing member biases the fitting member toward an outer peripheral surface of the second connection member. The holding element can maintain the relative positions of the first connection portion and the arm portion around the second axis firmly.

There may be provided a third connecting portion rotatably connecting the arm portion to the center of the sound emitting portion. In this case, the sound emitting portion can be positioned in a desired direction.

Further, a third holding element to maintain relative positions of the sound emitting portion and the arm portion around the third axis. In this case, even if there is provided the third connecting section, the sound emitting portion is prevented form being rotated wigglingly relative to the headband and generating strange noise when it is carried. Also, the arm portion can be prevented from being taken out of the allowable rotation range of the third connecting section, and the third connecting section can be prevented form being damaged inadvertently.

The third holding element may include end faces of mutually engageable accommodating counter members, and an inner surface of an accommodating portion, and a second biasing element biasing the end face and the inner face in the direction to come close to each other. In this case, the third holding element makes it possible to maintain the relative positions of the sound emitting portion and the arm portion around the third axis.

Further, either one of the end face or the inner face may have a convex portion, and remaining one of the end or inner face may have a concave portion. The convex portion and the concave portion may be formed so as to extend straightly. In this case, the third holding element makes it possible to maintain the relative positions of the sound emitting portion and the arm portion around the third axis definitely.

A plurality of the fitting counter parts may be provided so that the second biasing element is positioned between these fitting counter parts. In this case, the second holding element makes it possible to maintain the relative positions of the sound emitting portion and the arm portion around the third axis definitely.

### Embodiment

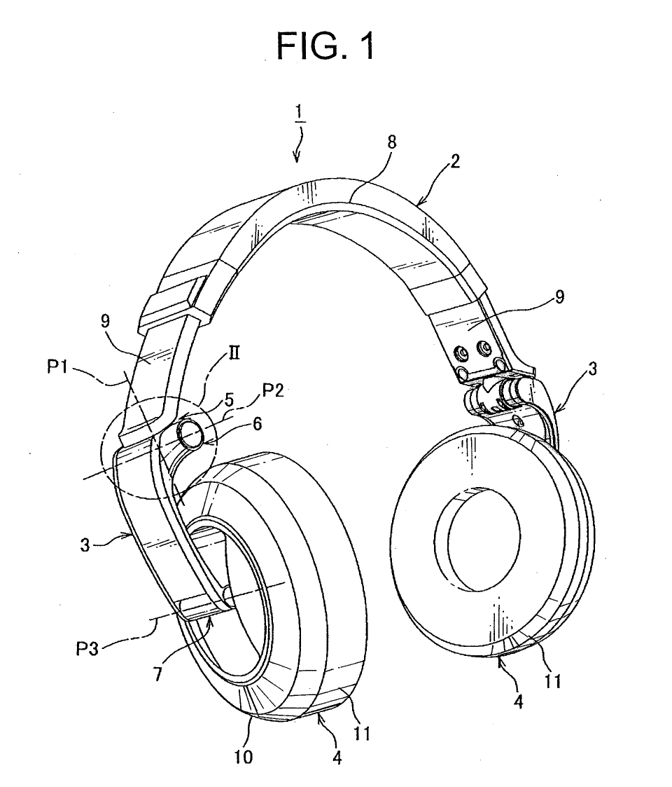

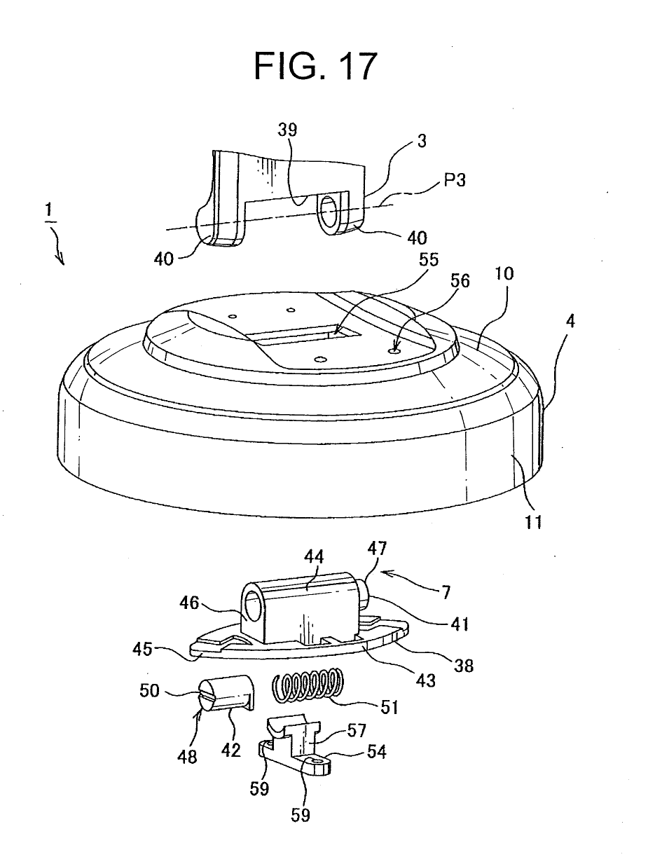

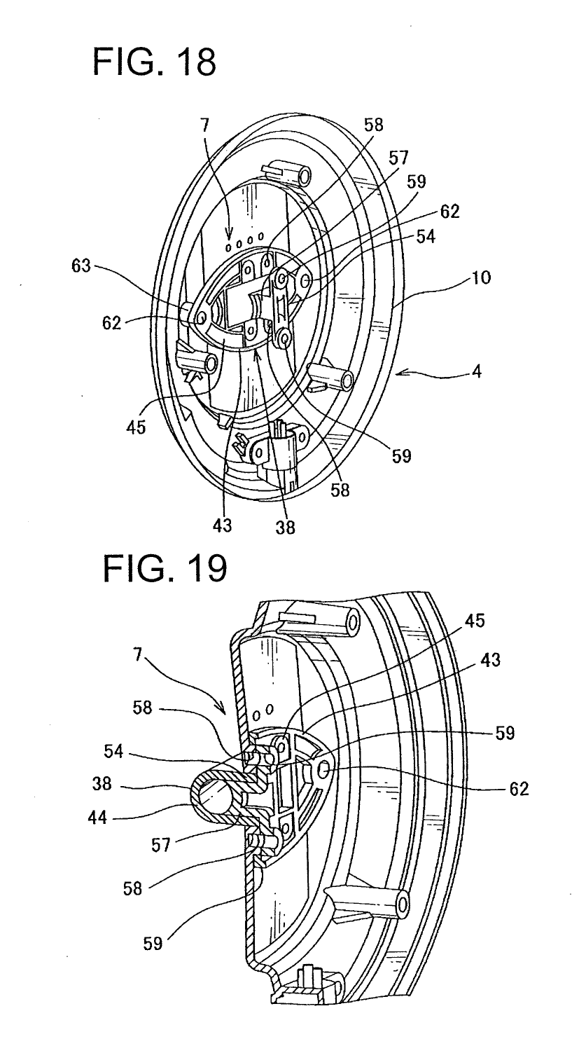

One embodiment of the present invention will be described with reference to FIGS. 1 to 12, and FIGS. 15 to 19. A headphone 1 shown in FIG. 1 is hung over the head of a user and produces and transmits the sound to the user.

As shown in FIG. 1, the headphone 1 includes an ear pad 11, a headband 2, a pair of arms portions 3, a pair of sound emitting portions 4, a pair of first connecting sections 5, a pair of second connecting sections 6, and a pair of third connecting sections 7.

As shown in FIG. 1, the headband 2 is formed to be C-shaped and includes a body 8 and a pair of telescopic portions 9 each telescopically attached to each end of the body 8. The headband 2 is formed to be gently curved strip-like shape along the contour of the user's head bridging body 8 and the telescopic portions 9. The headband 2 is hung over the user's head.

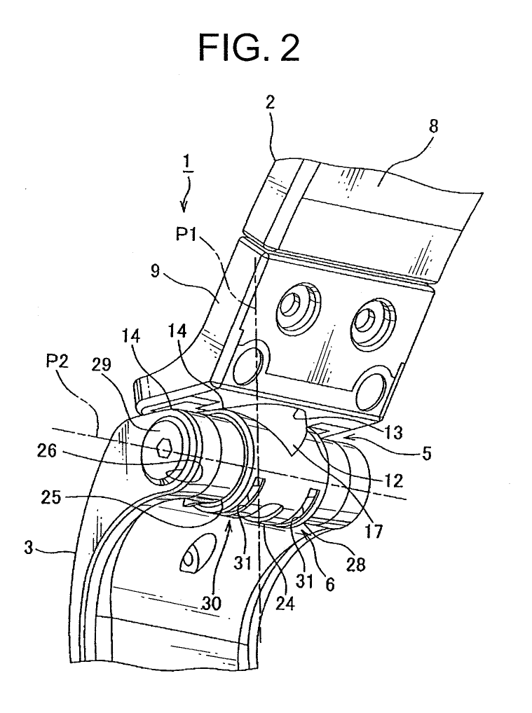

The arm portions 3 are formed to be a slightly curved strip-like shape. One end of the arm portions 3, as shown in FIG. 2, is attached to the telescopic portion 9 at the each end of the headband 2 via the first connecting section 5 and the second connecting section 6.

The sound emitting portions 4 are formed to be thick disc-like in shape. The sound emitting portion 4 includes a speaker case 10 formed of a hard synthetic resin and formed to be thick disc-like in shape, a speaker unit accommodated in the speaker case 10, and the ear pad 11.

A hole is provided for transmitting the sound produced by the speaker unit to the ear on each opposite side of the speaker cases 10, facing the user's ear (hereinafter referred to as a “sound emission side”) when the headband 2 is hunged over the use's head.

The speaker unit produces a sound according to voice currents when voice currents are input.

The ear pad 11 may be formed of an elastically deformable material such as foamed polyurethane resin or unwoven fabric and formed to be circular and annular in shape. The ear pad 11 is fixed to each peripheral portion and the sound emission side of the speaker 10.

The sound emitting portion 4 is attached (supported) to each other end of the arm portion 3 via the third connecting section 7.

The ear pad 11 can be in contact with the user's ear such that the user's ear is covered by the ear pad 11. Thus, a space formed between the sound emitting portion 4 and the user's ear can be air proof to improve acoustic charcteristic. Further, it is also possible to prevent the sound from be transmitted from outside and leaking outside.

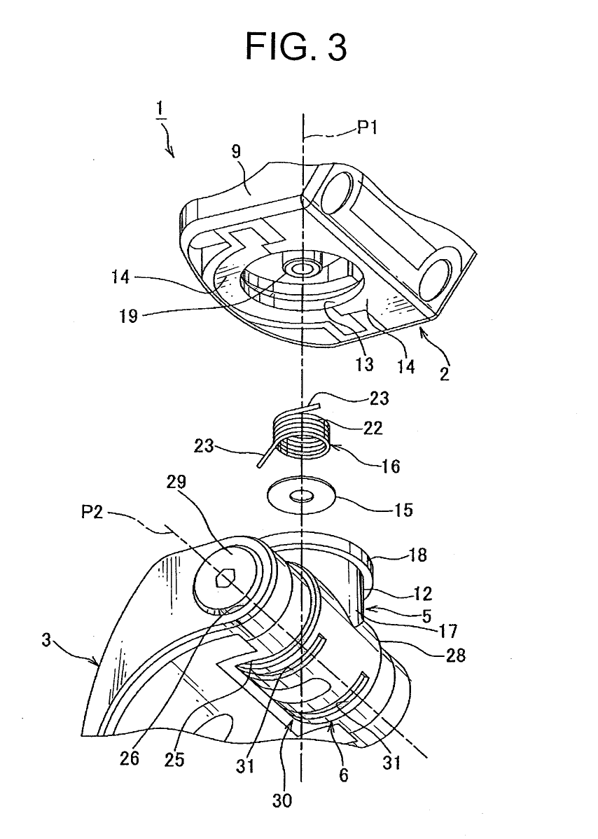

Referring to FIG. 3, the first connecting section 5 includes a first connection member 12 to which the arm portion 3 is attached via the second connecting members 6, a connecting hole 13 provided at a telescopic portion 9 namely headband 2, a pair of holding elements 14, a washer 15, and a torsion-coil spring 16 serving as a biasing element.

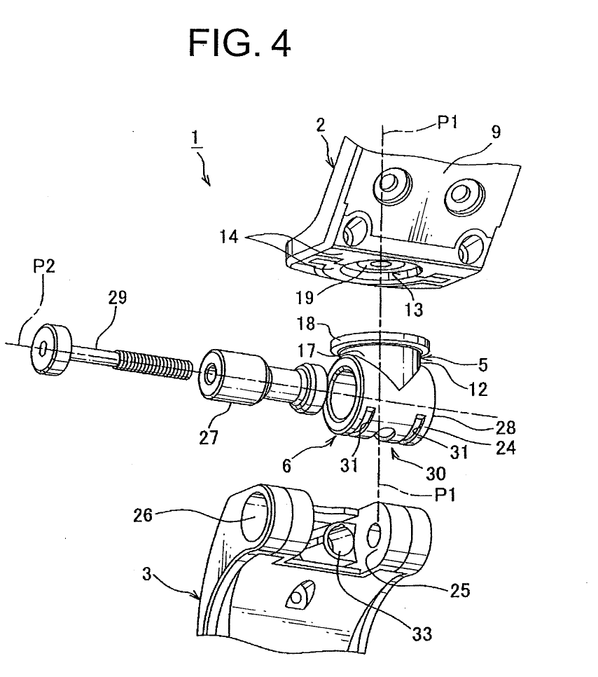

Referring to FIG. 4, the first connection member 12 includes a body 17 having a tubular shape, and a flange 18 radially protruding from a periphery of the body 17 in proximate of the telescopic portion 9 namely the headband 2.

The connecting hole 13 is formed to be concave with reference to an end face of the telescopic portion 9 and has a circular shape in plan view having a similarity shape with respect to the flange 18 of the first connection member 12 such that the flange 18 is rotatable in the connecting hole 13. Nevertheless, the flange 18 may be circular while the connecting hole 13 being elliptical or polygonal, as long as the flange 18 is allowed to be rotated in the connecting hole 13. To the contrary, the flange 18 may be elliptical or polygonal while the connecting hole 13 being circular. In this manner, there is no limitation as to the specific shape and dimensions.

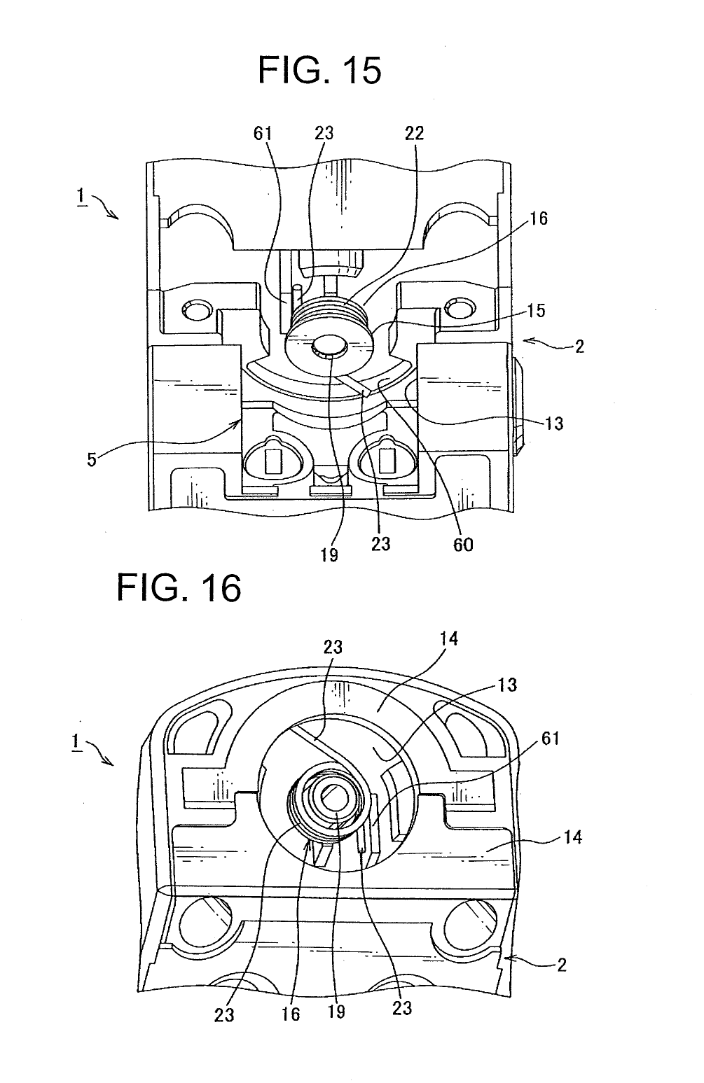

Referring to FIG. 3, a projection 19 is provided at a central portion of a bottom face of the connecting hole 13 protruding from the bottom face for positioning the torsion-coil spring 16. Further, as shown in FIG. 15, a concave region 6 is provided in an annular shape at the periphery of a bottom face of the connecting hole 13 such that the concave region 6 is depressed with respect to the bottom face.

Further, the flange 18 of the first connection member 12 has a convex projection 20 adapted to be inserted into a concave portion 60 of the connecting hole 13. The projection 20 is operable to be fitted with the concave portion 60 of the connecting hole 13 to restrict rotation of the first connection member. Although the concave portion 60 of the connecting hole 13 has a circular shape, other shapes such as an elliptical one is also possible as long as rotation of the first connection member can be restricted. Further, modifications can be made as appropriate, in such a manner, the connecting hole 13 includes the projection and the first connection member includes the concave portion 60.

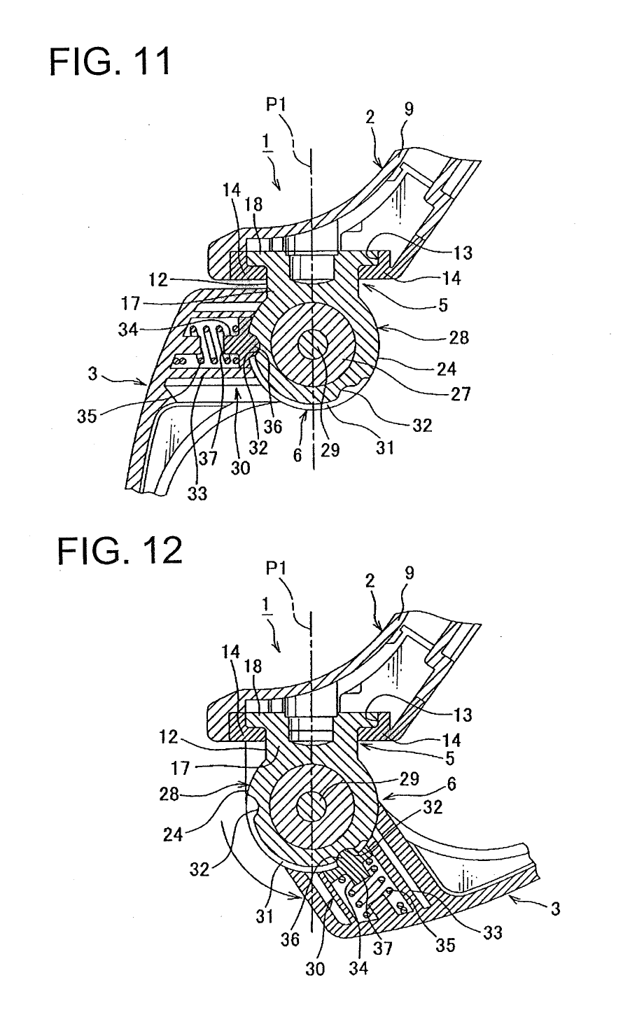

Further, as shown in FIGS. 11 and 12, the connecting hole 13 is constructed to receive therein an end of the body 17 proximate to the headband 2 and the flange 18 of the first connection member 12.

The pair of holding elements 14 each is a flat plate in shape having C-shape in a plan view. The pair of holding elements 14 are attached to the telescopic portion 9. When the pair of holding elements 14 is attached to the telescopic portion 9, as shown in FIGS. 11 and 12, the first connection member 12 is positioned therebetween, and the flange 18 is positioned between the holding element 14 bottom face. When the flange 18 is positioned between the bottom face of the connecting hole 13 and the holding elements 14, the first connection member 12 is rotatable relative to the headband 2 about the first axis P1 explained hereinafter.

The washer 15 is a circular ring in shape. The washer 15 is accommodated in the connecting hole 13 and arranged in a position of the body 17 close to the headband 2. The washer 15 is inserted together with the torsion-coil spring 16 into the projection 19 adapted to position the torsion-coil spring 16, and may be fastened and secured by a screw.

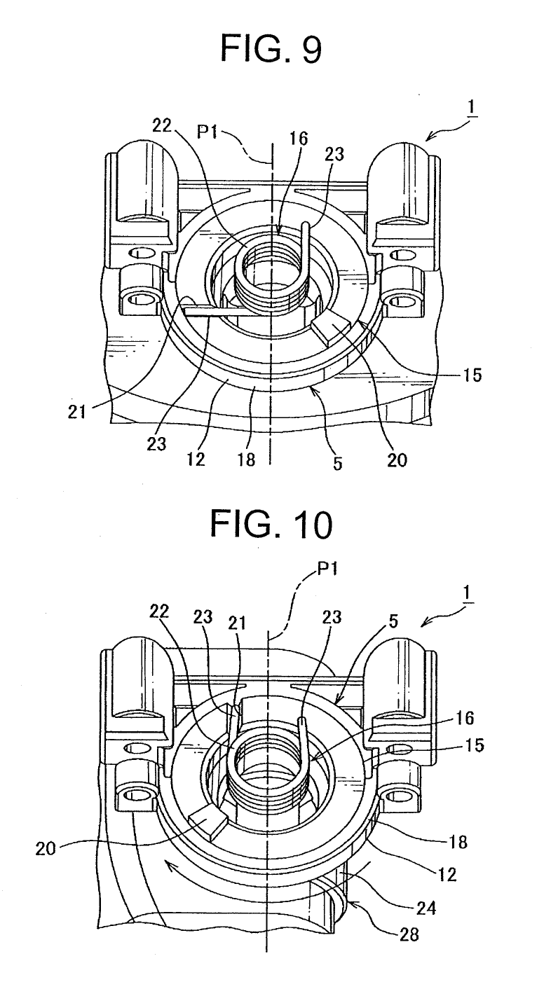

As shown in FIGS. 9 and 10, a projection 20 for regulating rotation and an assembling groove 21 are provided at the flange 18 of the first connection member 13. The projection 20 for regulating rotation protrudes from the surface of the flange 18 of the first connection member 13, the surface being close to the telescopic portion 9. The first connection member 12 namely, the arm portion 3 is attached to the telescopic portion 9 namely, the headband 2, when the first connection member is rotated about the first axis P1 hereinafter described, the projection 20 is brought into contact with the concave portion 60 provided on the bottom face of the connecting hole 13, so that the rotation range of the first connection member 12 namely, the arm 3 is restricted. The assembling groove 21 is formed to be concave with reference to the surface of the flange 18 of the first connection member 13, the surface being proximate to the telescopic portion 9. The assembling groove 21 is constructed to accommodate one of the rod-shaped portions 23 of the torsion-coil spring 16 which will be explained hereinafter, so that the bar-shaped portion 23 is secured.

In the first connecting portion 5 having the configuration described above, when the first connection member 12 is attached to the telescopic portion 9 namely, the headband 2, the first connection member 12 is rotatable about the first axis P1 (indicated by a dotted chain line in FIG. 1) relative to the headband 2, the first axis P1 being parallel to the orientation directed from the headband 2 toward the arm portion 3. In other words, since the first connection component 12 is attached via the second connecting part 6 to the arm portion 3, the first connection member connects the arm portion 3 to the headband 2 such that the arm portion 3 is rotatable about the first axis P1. The first axis P1 is coaxial with respect to the first connection member 12 (serving as an axis for the first connection member 12).

The torsion coil spring 16 is made of a metallic wire material such as iron and phosphor bronze. As shown in FIGS. 9 and 10, the torsion-coil spring 16 includes an elastically deformable member 22 made by the wire material coiled in a circular-ring fashion, and a pair of rod-shaped portions 23 extending from the elastically deformable member 22 and radially outward of the elastically deformable member 22.

The torsion coil spring 16 is accommodated in the first connection member 12, and the torsion coil spring 16 is positioned in a state in which the projection 19 in the connecting hole 13 is inserted into the torsion coil spring 16. The one of the rod-shaped portions 23 of the torsion coil spring 16 is received in the assembling groove 21. The torsion coil spring 16 in combination with the washer 15 is attached or secured to the telescopic portion 9 by means of a screw. The other one of the rod-shaped portions 23 of the torsion coil spring 16 is attached or secured to an inner surface of the connecting hole 13, namely, the headband 2.

More specifically, as shown in FIGS. 15 and 16, the other one of the rod-shaped portions 23 is positioned so as to extend along the lateral face of a wall portion 61 protruding from the bottom face of the connecting hole 13, and is adhered to the wall portion 61. The wall portion 61 is provided on the side facing to the concave portion 60, with the torsion coil spring 16 which is disposed therebetween the wall portion 61 and the concave 60 so as not to interfere with movement of the one of the rod-shaped portions 23 in the circumferential direction. Although the wall portion 61 is formed in a direction crossing the direction in which the concave portion 60 extends, the invention is not limited to this embodiment. The wall portion 61 may extend in the direction in which the concave portion 60 extends, and wall portion may be modified as required in order to obtain a desired elastic restoring force.

The one of the rod-shaped portions 23 of the torsion coil spring 16 is attached to the first connection member 12, namely, the arm portion 3, and the other one of the rod-shaped portions 23 is attached to the connecting hole 13, namely, the headband 2. When the first connecting portion 5, namely, the arm portion 3 connected thereto is rotated about the first axis P1, as shown in FIG. 10, the elastically deformable member 22 is elastically deformed for enlargement and contraction. FIG. 10 shows the state in when the elastically deformable member is enlarged. Needless to say, the elastic restoring force is produced that urges the member to be restored to the neutral state in which elastic deformation no longer exists.

In FIG. 9, the one end of the rod-shaped portions 23 and the other end of the rod-shaped portions 23 extend vertically from the elastically-deformable member 22.

Needless to say, the present invention is not limited to this embodiment. For example, the rod-shaped portions 23 may extend at a predetermined angle such as 120 degrees, which can be modified as required to obtain a predetermined elastic restoring force. Further, in place of the torsion coil spring 16, a single elastic member (for example, a resin material such as natural resin including a rubber and polyurethane including spunbond) may be coiled around the projection 19 of the connecting hole 13 to obtain the elastic restoring force. Modifications may be made as required.

In the neutral state in which the torsion coil spring 16 is not elastically deformed shown in FIG. 9, the headband 2 and the arm portion 3 are positioned in the neutral position in which the surface of the telescopic portion 9 and that of the headband 2 is substantially parallel to the surface of the arm portion 3 (as shown in FIG. 1). In this manner, when the arm portion 3 is rotated about the first axis P1, the torsion coil spring 16 biases the arm portion 3 toward the neutral position in which the arm portion 3 and the headband 2 are parallel to each other. It should be noted that, in the specification, the neutral position refers to a position in which a difference in level between the arm portion 3 and the headband 2 becomes the smallest. The neutral position in the context of the specification does not imply that the surface of the headband 2 and the surface of the arm portion 3 are completely parallel to each other. In other words, the neutral position means the position where the angle defined by the direction in which the surface of the arm portion 3 extends (from the sound emitting portion 4 to the headband 2) and the direction in which the surface of the headband 2 extends (the direction from the arm portion 3 toward the central portion of the headband 2) is minimum. Accordingly, the neutral position in the context of the specification does not imply that the angle defined by the surface of the headband 2 and the surface of the arm portion 3 becomes completely zero degree.

Referring to FIG. 4, the second connecting section 6 includes a second connection member 24, a notch 25 provided at the arm portion 3, an insertion hole 26 provided at the arm portion 3, and a shaft 27.

The second connection member 24 is a tubular in shape. The second connection member 24 is made to be integral with the first connection member 12, continuing to an end of the first connection member 12, with the axis of the second connection member 24 intersecting with the axis of the first connection member 12 (in an orthogonal manner in the illustrated drawings). Specifically, the second connection member 24 is made integrally with the first connection member 12 to constitute a connection member 28. In this manner, the headphone 1 includes the connection member 28.

The notch 25 is formed at an end of the arm portion 3 in such a manner that the end of the arm portion 3 is notched directing toward the central portion of the arm portion 3 from edge of the end of the arm portion 3 so as to constitute the notch 25. The notch 25 is adapted to receive therein the second connection component 24. The insertion hole 26 is provided at the end of the arm portion 3. The insertion hole 26 is circular in cross section and is arranged in such a manner that the insertion hole 26 is coaxially with (and in communication with) the second connection member 24 disposed in the notch 25.

The shaft 27 is formed to be a columnar in shape whose outer diameter varies in a stepwise fashion. The shaft 27 is inserted into the insertion hole 26 and the second connection component 24. The shaft 27 is secured to the arm portion 3 by the fixing bolt 29 (as shown in FIG. 4). The second connection member 24 is attached to the arm portion 3 with the shaft 27 passing through the second connection member 24 secured to the arm portion 3 via the fixing bolt 29. Further, since the shaft 27 is passed through the second connection member 24, the second connection member 24 is understandably constructed to accommodate the shaft 27. Further, when the shaft 27 passed through the second connection member 24 is secured via the fixing bolt 29 to the arm portion 3, the second connection member 24 is rotatable relative to the arm portion 3 about the second axis P2 in the direction substantially parallel to the width of the headband 2 and orthogonal to the first axis P1.

The second connecting section 6 having the configuration described above is constructed to connect the arm portion 3 to the first connecting section 5 such that the arm portion 3 and the first connecting section 5 are rotatable about the second axis P2 shown by a dotted chain line in FIG. 1. The second axis P2 is coaxial with the second connection member 24 (and constitutes an axis of the second connection member 24). In this manner, the second connecting section 6 makes the arm portion 3 rotatable about the second axis P2 with respect to the first connecting portion 5, namely the headband 2 so that the position of the arm portion 3, namely, the sound emitting portion 4 can be variable between an expanded state of the sound emitting portion 4 shown in FIG. 11 and a folded state of the sound emitting portion 4 shown in FIG. 12.

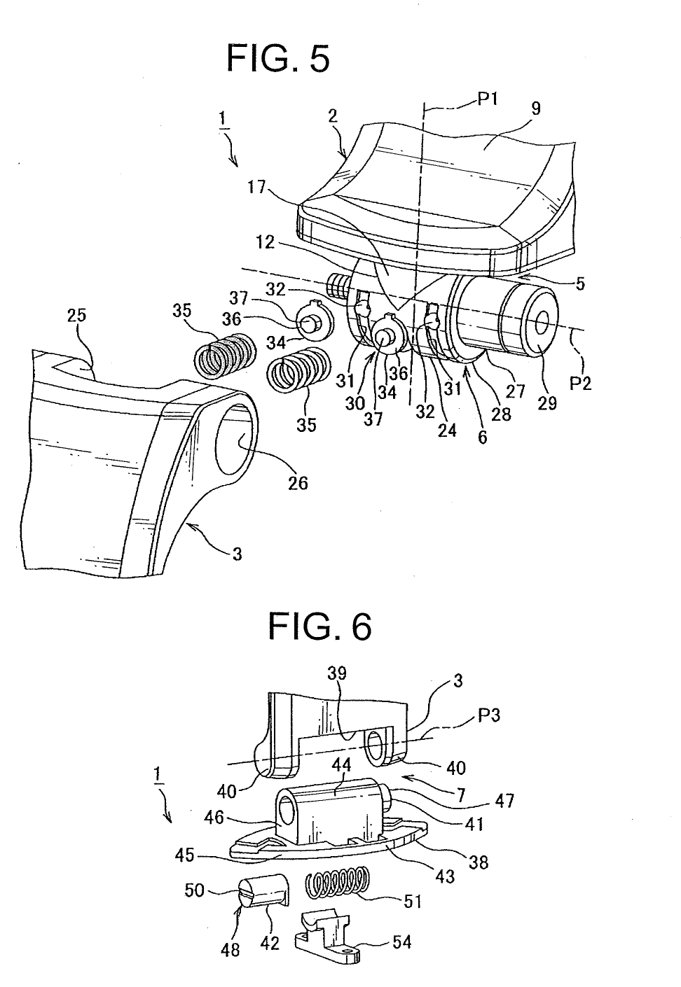

Referring to FIG. 5, the headphone 1 includes a retention structure 30 as a second holding member. The retention structure 30 shown in FIG. 5 includes a plurality of grooves 31, a plurality of round concave portions 32 as a fitting counter part, a plurality of accommodating holes 33 (shown in FIGS. 11 and 12), a plurality of protruding plates 34 as a fitting member, and a plurality of coil springs 35 as a first biasing member.

Two grooves 31 are illustrated in the figures. The grooves 31 are depressed with reference to the peripheral face of the second connection member 24 and each extends along the circumferential direction of the second connection member 24. These two grooves 31 are spaced from each other along the axis of the second connection member 24, i.e., along the second axis P2. The grooves 31 are not limited to two in number. Three, four or any other grooves may be. A plurality of the round concave portions 32 as the fitting counter part may be formed corresponding to the number of grooves 31.

A plurality of the round concave portions 32 are provided on the corresponding each of the grooves 31. In the drawing, two round concave portions 32 are provided for each of the grooves 31 namely four in total. The round concave portions 32 are arranged in an interval from each other in a lengthwise direction of the grooves 31, namely, along the circumferential direction of the second connection member 24. The round concave portion 32 is depressed from the peripheral face of the second connection member 24 and the bottom face of the grooves 31. The round concave portion 32 is circular in shape in plan the view. In stead of the round concave portion 32, a concave portion having an elliptical shape or polygonal shape may be provided on the outer circumferential face of the second connection member 24. Any modifications in shape can be made as required.

Two accommodating holes 33 are illustrated in the drawings. The accommodating hole 33, faces the grooves 31 provided at the end of the arm portion 3 with the opening thereof provided on the second connection member 24.

Two protrusive plates 34 are illustrated in the drawings. The protrusive plate 34 includes a hemispherical round portion 36, and a columnar portion 37 continuing to a flat bottom face of the round portion 36 which are integral with the protrusive plate 34. The round portion 36 and the columnar portion 37 are coaxial with respect to each other. The round portion 36 is operable to be in contact with the bottom face of the round concave portion 32 fitting with the round concave portion 32. Further, the columnar portion 37 has a diameter smaller than that of the round portion 36. The protrusive plate 34 is loosely inserted into the accommodating hole 33 with the round portion 36 being opposed to the second connection member 24. The protrusive plate 34, loosely inserted into the accommodating hole 33, is operable to be raised and depressed from the arm portion 3 toward the second connection member 24. Obviously, the protrusive plate 34, whose round portion 36 is fitted into the round concave portion 32, can be fitted into the round concave portion 32. It suffices that the round portion 36 has a dimension corresponding to the round concave portion 32. If the concave portion is elliptical or polygonal in shape in stead of the round concave portion 32, the round portion 36 also may be elliptical or polygonal. Any modifications can be made as required.

Two coil springs 35 are illustrated in the drawings. The coil spring 35 is accommodated in the accommodating hole 33 to be disposed between the bottom face of the accommodating hole 33 and the protrusive plate 34. The coil spring 35, which is disposed between the bottom face of the accommodating hole 33 and the protrusive plate 34, is constructed to bias the protrusive plate 34 toward the second connection member 24. In place of the coil spring 35, a member made of a rubber as an elastic member may be used, or a member made of polyurethane resin may also be used, as long as the protrusive plate 34 can be biased toward the second connection member 24. A known elastic member may be selected and used as required in place of the coil spring 35 for the purpose of adjusting biasing force.

The retention structure 30 having the configuration explained above permits the round the round portion 36 of the protrusive plate 34 to be in close contact with grooves 31 by biasing the protrusive plate 34 toward the second connection member 24 by the coil spring 35 so that the protrusive plate 34 may be received in the accommodating hole 33 opposite to the grooves 31. Also the retention structure 30 maintains the relative positional relationship about the second axis P2 between the first connecting section 5 and the arm portion 3 so that the round portion 36 of the protrusive plate 34 enters the round concave portion 32 and is brought into fitting with the round concave portion 32.

The third connecting section 7, as illustrated in FIGS. 6, 8, and 17 to 19, includes a case holder 38 adapted to be attached to the sound emitting portion 4, a notch 39, an accommodating portion 40 integral with the arm portion 3, a fixing connecting shaft 41, and a sliding connecting shaft 42 which is accommodating counter portion as accommodating counter member.

The case holder 38 integrally includes a flat plate-shaped holder body 43 adapted to be attached to the central portion of backside (namely opposite side) on the sound emission side of the sound emitting portion 4, and a tubular portion 44 provided on the holder body 43.

The holder body 43 is secured to the central portion on the backside of the sound emitting portion 4. The tubular portion 44 is formed to be cylindrical. The axis of tubular portion 44 extends substantially in parallel with the surface of the holder body 43.

The notch 39 is formed at the other end of the arm portion 3 having a portion of the arm portion 3 partly cut away from edge of the end thereof toward the central portion of the arm portion 3. The tubular portion 44 of the case holder 38 is disposed in the notch 39.

The accommodating portion 40 is tubular in shape having a bottom. A pair of the accommodating portion 40 are provided at the other end of the arm portion 3. The accommodating portion 40 has an opening facing the notch 39. The accommodating portion 40 is placed coaxially with (and in communication with) the tubular portion 44 of the case holder 38 disposed in the notch 39.

The fixing connecting shaft 41 integrally includes a flat plate-shaped fixing part 45, an upstanding portion 46 upstanding from the fixing part 45, and a columnar tubular portion 47 connecting with one end of which is connected to the upstanding portion 46. The fixing part 45 overlaps with the backside of the sound emitting portion 4 and secured to the sound emitting portion 4. The tubular portion 47 is accommodated in the case holder 38 with its end entering an inside of the accommodating portion 40. The tubular portion 47 enters the accommodating portion 40 so as to be rotatable with respect to the accommodating portion 40.

The sliding connecting shaft 42 is columnar in shape. The sliding connecting shaft 42 is accommodated in the tubular portion 44 of the case holder 38, with its end entering an inside of the accommodating portion 40. The sliding connecting shaft 42, which is accommodated in the tubular portion 44 of the case holder 38, is attached to the sound emitting portion 4 via the case holder 38. The sliding connecting shaft 42 with its end entering the accommodating portion 40 is accommodated in the accommodating portion 40 so as to be rotatable about the third axis P3 with respect to the accommodating portion 40. The sliding connecting shaft 42 enters the accommodating portion 40 so as to be rotatable with respect to the accommodating portion 40. Further, the sliding connecting shaft 42 is movable along the axis.

The third connecting section 7 having the configuration described above is configured to connect the sound emitting portion 4 to the arm portion 3 such that the arm portion 3 is rotatable about the third axis P3 shown by the dotted chain line in FIG. 1 extending along the width direction of the arm portion 3 with the tubular portion 47 of the fixing connecting shaft 41 and the sliding connecting shaft 42 being rotatable relative to the accommodating portion 40. The third axis P3 extends in parallel with the second axis P2 in a state where the first connection member 12 of the first connecting section 5 is positioned at the neutral position.

The case holder 38 constituting the third connecting section 7 is arranged in such a manner that the tubular portion 44 is passed through the opening 55 provided proximate to the central portion of the speaker case 10 and the tubular portion 44 protrudes toward the arm portion 3.

A fastening member (namely screw) is inserted into a throughhole 62 provided in the case holder 38 and the concave portion 63 provided in the speaker 10 having a threaded inner surface so that the case holder 38 is secured to the speaker case 10. In order to support sliding connecting shaft 42 and the coil spring 51 accommodated in the case holder 38, the projection 57 of the spring support member 54 is inserted into the case holder 38. The fastening member (namely screw) which passes through the throughhole 59 formed in the spring support member 54 is inserted into the concave portion 58 provided in the speaker case 10 having the threaded inner surface so that the spring support member is secured to the speaker case 10.

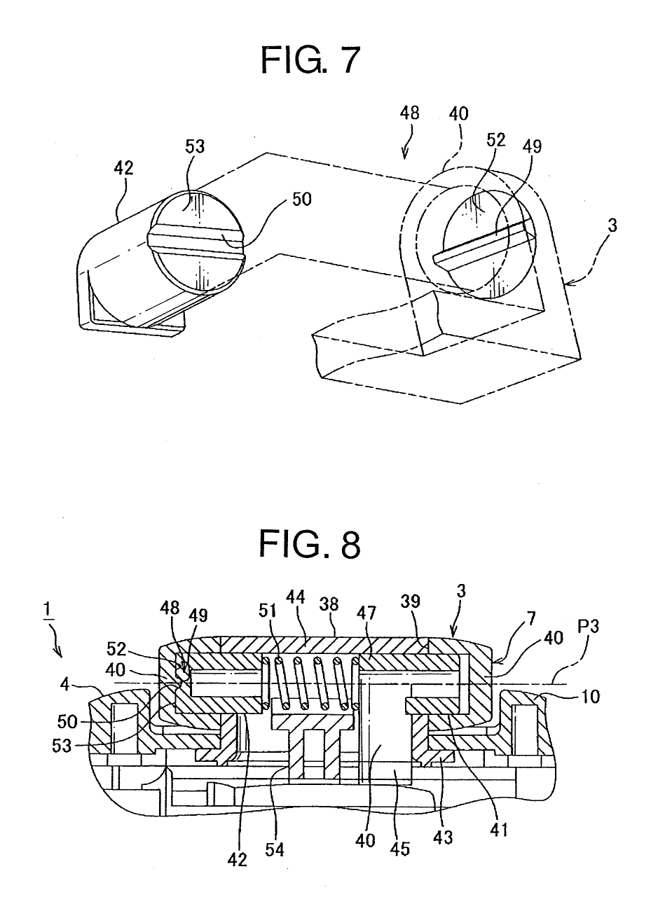

Further, the headphone 1 includes a second retention structure 48 which is a third holding element. The second retention structure 48, as shown in FIG. 7, includes a back face 52 which is the inner face of the accommodating portion 40 for engagement of the accommodating portion 40 with the sliding connecting shaft 42, an end face 53 of the sliding connecting shaft 42, a straightly convex portion 49, a straightly concave portion 50 and a coil spring 51 as a second biasing element shown in FIG. 8.

The straightly convex portion 49 is raised from the back face 52 of the innermost of the accommodating portion 40 among the inner faces of the accommodating portion 40 into which the sliding connecting shaft 42 of each of the third connecting sections 7 enters. The back face 52 is opposed to the end face 53 of the sliding connecting shaft 42 which will be explained hereinafter. The straightly convex portion 49 extends passing the center of the back face 52 in a linear fashion.

The straightly concave portion 50 is depressed from the end face 53 which lies the innermost of the accommodating portion 40 of the sliding connecting shaft 42 of each of the third connecting section 7. The straightly concave portion 50 extends straightly passing through the center of the end face 53. The straightly convex portion 49 is adapted to be inserted into the straightly concave portion 50. When the straightly convex portion 49 enters the inside of the straightly concave portion 50, an outer face of the straightly convex portion 49 is brought into close contact with the inner face of the straightly concave portion 50, and the end face 53 is brought into close contact with the back face 52. Through the outer face of the straightly convex portion 49 brought into close contact with the inner face of the straightly concave portion 50, and the end face 53 brought into close contact with the back face 52, the straightly convex portion 49 is brought into engagement with the straightly concave portion 50.

The coil spring 51 is disposed between the sliding connecting shaft 42 and the fixing connecting shaft 41 of each of the third connecting sections 7 so as to bias the sliding connecting shaft 42 to the back of the accommodating portion 40, namely, to bias the end face 53 toward the back face 52. Further, the coil spring 51 is disposed between the shafts 41 and 42 by virtue of the spring support member 54 (shown in FIG. 8) attached to the sound emitting portion 4. In place of the coil spring 51, a member made of an elastic member such as a rubber may be used, or a member made of polyurethane resin may be used as long as the sliding connecting shaft 42 can be biased toward the back of the accommodating portion 40. In other words, the end face 53 can be biased so as to become close to the back face 52. Thus, a known elastic member may be selected for use in place of the coil spring 35 for the purpose of adjusting biasing force. Further, the straightly convex portion 49 and the straightly concave portion 50 do not need to be straightly extended as long as they are engageable with each other.

The second retention structure 48 having the configuration described above is configured to maintain the relative positions about the third axis P3 between the sound emitting portion 4 and the arm portion 3 by means of the coil spring 51 biasing the sliding connecting shaft 42 toward the back of the accommodating portion 40, and the straightly convex portion 49 being brought into engagement with the straightly concave portion 50.

The headphone 1 having the configuration described above is used by putting the headband 2 on the user's head so as to have the ear pad 11 of the sound emitting portion 4 cover the user's ear, supply voice currents to each of the speaker units of the sound emitting portion 4, reproduce sounds corresponding to the voice currents and transmit the reproduced sounds to the user.

According to this embodiment, when the arm portion 3 supporting the sound emitting portion 4 is rotated about the first axis P1 with respect to the headband 2, the torsion-coil spring 16 biases the arm portion 3 toward the neutral position. For example, when the sound emitting portion is brought into contact with the ear of the user so that the user can listen to the reproduced sounds coming from the speaker and the user can also listen to an external sound by directing the sound emitting portion to the opposite side the ear of the user's ear. When the user listens again to the reproduced sounds, the arm portion 3 is restored to the neutral position by virtue of the biasing force of the torsion-coil spring 16.

Accordingly, when the sound emitting portion 4 is in use, the arm portion 3 is kept in the neutral position. When the sound emitting portion 4 is not in use, the sound emitting portion can be rotated to be directed in a desired direction. Further, the sound emitting portion 4 is prevented against being rotated wigglingly with respect to the headband 2 during the headphone is carried by the user, so that occurrence of strange noise can be avoided. Further, since the arm portion 3 and the sound emitting portion 4 can be positioned in the neutral position, the arm portion 3 can be protected against being taken out of the allowable rotation range of the first connecting section 5, and it is possible to prevent inadvertent damage to the first connecting section 5.

Also, the torsion-coil spring 16 includes the circular ring-shaped elastically-deformable member 22 and the pair of rod-shaped portions 23, one of the rod-shaped portions 23 is attached to the arm portion 3, and the other rod-shaped portions 23 is attached to the headband 2. Thus, only a simple structure can perform that for the torsion-coil spring 16 to bias the arm portion 3 toward the neutral position.

Further, in addition to the first connecting section 5, there is provided the second connecting section 6 constructed to connect the first connecting section 5 to the arm portion 3 rotatably about the second axis P2 at right angles to the first axis P1. This construction and arrangement makes it possible to fold the sound emitting portion 4 such that the sound emitting portion 4 is in close contact with the headband 2.

Also, there is provided the connection member 28 that includes the first connection member 12 constituting the first connecting section 5 and the second connection member 24 constituting the second connecting section 6. According to this construction and arrangement, even when there are the first connecting section 5 and the second connecting section 6, increase in the number of components can be restrained.

Further, the first connection member 12 is formed in the tubular shape accommodating the torsion-coil spring 16, and the second connection member 24 is formed in the tubular shape accommodating the shaft 27. This construction and arrangement makes it possible to prevent the headphone 1 from becoming excessively large even when there is the second connecting section 6 in addition to the first connecting section 5.

Also, there is provided the retention structure 30 constructed to maintain the relative positional relationship about the second axis P2 between the first connecting section 5 and the arm portion 3. According to this construction, even when there is provided the second connecting section 6 addition to the first connecting section 5, the sound emitting portion 4 is protected against being rotated wigglingly with respect to the headband 2 while the headphone is carried by the user, and it is possible to prevent occurrence of strange noise. The arm portion 3 is protected against being erroneously taken out of the allowable rotation range with respect to the second connecting section 6, and it is possible to prevent inadvertent damage to the second connecting section 6.

Further, the retention structure 30 includes the round concave portions 32 in the outer peripheral face of the second connection member 24 spaced from each other circumferentially thereof, the protrusive plate 34 being operable to be raised and depressed from the arm portion 3 and constructed to be fitted into the round concave portion 32, and the coil spring 35 that biases the protrusive plate 34 toward an outer periphery of the second connection member 24. This construction and arrangement makes it possible for the retention structure 30 to maintain the relative positional relationship about the second axis P2 between the first connecting section 5 and the arm portion 3.

Also, there is provided the third connecting section 7 that rotatably connects the arm portion 3 to the central portion of the sound emitting portion 4. This construction and arrangement allows the sound emitting portion 4 to be directed in any desired directions.

Further, there is provided the second retention structure 48 constructed to maintain the relative positional relationship about the third axis P3 between the sound emitting portion 4 and the arm portion 3. According to this construction and arrangement, even when there is the third connecting section 7, the sound emitting portion 4 is protected against being rotated wigglingly with respect to the headband 2 while the headphone is carried by the user. Thus, it is possible to prevent occurrence of strange noise. The arm portion 3 is protected against being erroneously taken out of the allowable rotation range with respect to the third connecting section 7. Thus, it is possible to prevent inadvertent damage to the third connecting section 7.

Also, the second retention structure 48 includes the back face 52 and the end face 53, which are engageable with each other, and the coil spring 51 that biases the back face 52 and the end face 53 in the direction in which these two elements become close to each other. Further, the back face 52 includes the straightly convex portion 49, and the end face 53 includes the straightly concave portion 50, such that the straightly convex portion 49 and the straightly concave portion 50 extend in a linear fashion. This construction and arrangement makes it possible for the second retention structure 48 to maintain the relative positional relationship about the first axis P1 between the sound emitting portion 4 and the arm portion 3.

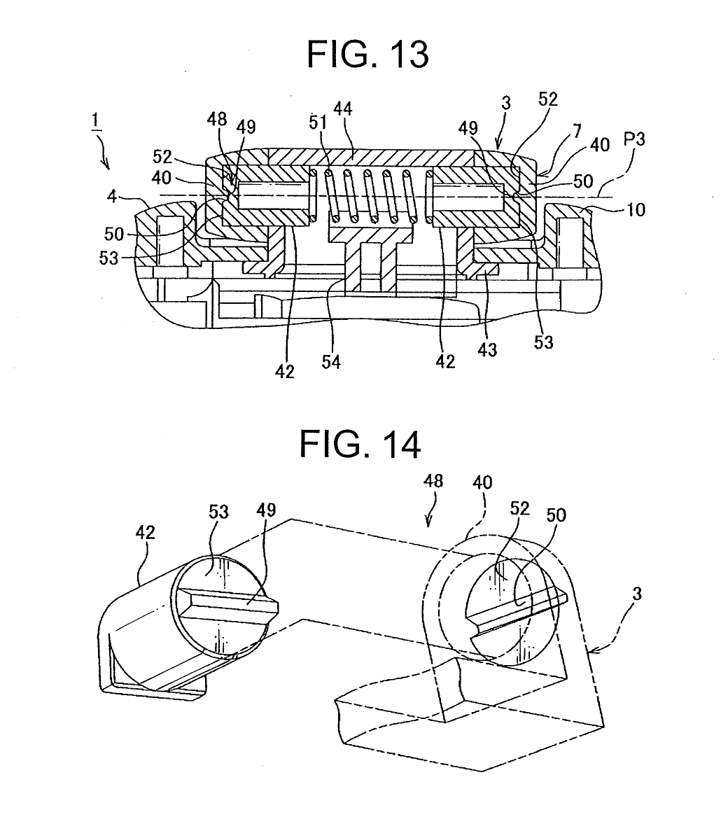

In the embodiment explained above, each of the third connecting sections 7 includes the fixing connecting shaft 41 and the sliding connecting shaft 42. The present invention, as shown in FIG. 13, the third connecting sections 7 may include a pair of (namely a plurality of) the sliding connecting shafts 42, and the coil spring 51 of the second retention structure 48 may be disposed between the pair of (namely the plurality of) the sliding connecting shafts 42. In this case, it is possible for the second retention structure 48 to maintain the relative positional relationship about the third axis P3 between the sound emitting portion 4 and the arm portion 3. In FIG. 13, the same elements as in the embodiment described above are denoted by the same reference numerals, detailed description of which is omitted.

Further, in the embodiment described above, the straightly convex portion 49 is provided on the back face 52, and the straightly concave portion 50 is provided on the end face 53. The present invention, as shown in FIG. 14, may include the straightly convex portion 49 on the end face 53 and the straightly concave portion 50 on the back face 52. In FIG. 14, the same elements as in the embodiment described above are denoted by the same reference numerals, detailed description of which is omitted.

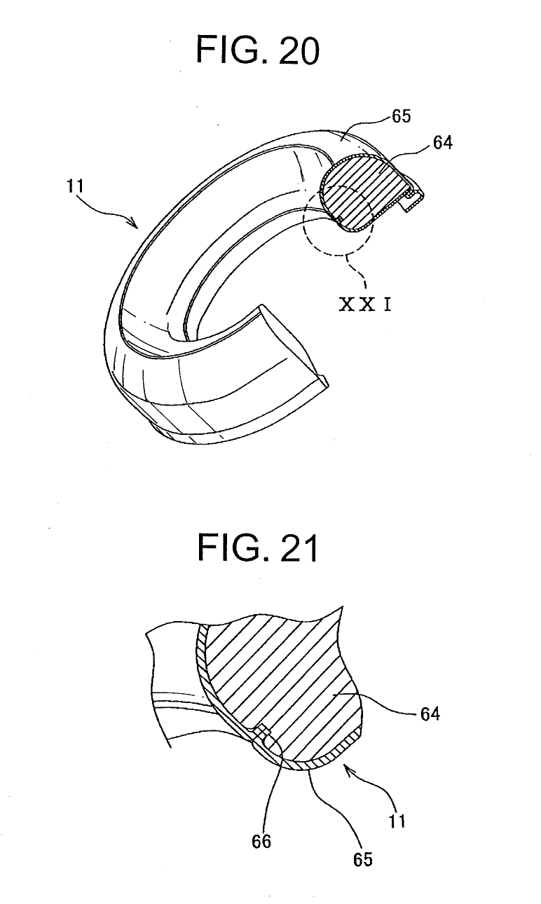

Next, the ear pad according to one embodiment of the present invention will be described with reference to FIGS. 20 and 21.

Referring to FIG. 20, the ear pad 11 includes a cushion member 64 and a cover 65 covering the cushion member 64.

The cushion member 64 is formed of a known material such as expanded polyurethane foam made of polyurethane resin.

The cover 65 is made of a known material such as a film of polyurethane resin, a sheet (fabric material) made by applying a synthetic resin for adhesion to a nonwoven fabric. The former has a relatively low breathability, and the latter has a relatively high breathability. In particular, in order to ensure the sound-isolating property of the sound emitting portion 4 with respect to the user's ear, it is preferable to make the cover 65 with a material having a relatively low breathability.

The cover 65 is adapted to cover the cushion member 64 and defines the sound-isolating space, which is formed of a single sheet member welded or sewn onto the cushion member 64.

An interface 66 (shown in FIG. 21) to be joined by welding or sewing may lose a bonding force at the interface 66 under a severe usage environment, resulting detachment or deformation of the entire cover 65. Further, as the bonding force of the interface 66 weakens, it becomes difficult to define the sound-isolating space in the cover 65, and as a result the sound-isolating property between the sound emitting portion 4 and the user's ear may be degraded. In particular, when the interface 66 is constructed by sewing, the sound-isolating property of the space within the cover 65 is relatively small when compared with an interface constructed by welding.

To make the bonding force of the interface 66 relatively large, this embodiment combines sewing and welding to achieve bonding. By combining welding and sewing, the sewing prevents the bonding force of the interface 66 from getting weakened even when an external force acts upon the interface 66 in a direction in which detachment of the interface 66 is induced. Also, welding can augment the sound-isolating property which might be insufficient when only sewing is employed.

### INDUSTRIAL APPLICABILITY

According to an aspect of the present invention it is possible to obtain the headphone 1 which is summarized as follows.

The headphone 1 comprising: the headband 2; the strip-shaped arm portion 3; the sound emitting portion 4 supported by the arm portion 3; the first connecting section 5 constructed to connect the arm portion 3 to the headband 2 rotatably about the first axis P1 parallel to the direction in extending from the headband 2 toward the arm portion 3; and the torsion coil spring 16 constructed to bias the arm portion 3 so that the arm portion 3 is in the neutral position with respect to the headband 2 as the arm portion 3 is rotated about the first axis P1.

According to another aspect of the present invention, the headphone includes the torsion-coil spring 16 constructed to bias the arm portion 3 of the headphone toward the neutral position as the arm portion 3 supporting the sound emitting portion 4 is rotated with respect to the headband 2 about the first axis P1. This construction allows the user to listen to a reproduced sound coming from a speaker unit of the sound emitting portion 4, with the sound emitting portion 4 being in contact with the user' ear. Also, the construction allows the user to hear external sounds with the sound emitting portion 4 directed in an opposite direction with respect to the user's ear. Further, the construction allows the user to listen again to the reproduced sound with the arm portion 3 restored to the neutral position by virtue of the biasing force exerted by the torsion-coil spring 16.

Accordingly, when the sound emitting portion 4 is in use, the arm portion 3 is kept in the neutral position. When the sound emitting portion 4 is not in use, it is possible to rotate the sound emitting portion 4 to be directed in a desired direction. Further, it is possible to avoid occurrence of strange noise. Further, since the arm portion 3 or the sound emitting portion 4 connected thereto can be positioned in the neutral position, the arm portion 3 can be protected against being taken out of the allowable rotation range of the first connecting section 5, and it is possible to prevent inadvertent occurrence of damage to the first connecting section 5.

It should be noted that the above-described embodiments are typical exemplary ones of the present invention and therefore the present invention is not limited to these embodiments. The present invention can be effectuated with various modifications within the scope and the spirit of the present invention.

1. A headphone comprising:
a headband;
a strip-shaped arm portion;
a sound emitting portion supported by the arm portion;
a first connecting section connecting the arm portion to the headband such that the arm portion is rotatable about a first axis, the first axis being parallel to a from headband to arm portion orientation; and
a biasing element biasing the arm portion toward the neutral position relative to the headband when the arm portion is rotated about the first axis.

2. The headphone according to claim 1, wherein the biasing element includes a ring-shaped elastically-deformable member and a pair of rod-shaped portions each extending from the elastically-deformable member outward of the elastically-deformable member, one of the pair of rod-shaped portions being attached to the arm portion and an other thereof being attached to the headband.

3. The headphone according to claim 2 comprising a second connecting section connecting the arm portion to the first connecting section such that the arm portion is rotatable about a second axis extending in a width direction of the headband and being orthogonal to the first axis.

4. The headphone according to claim 3 comprising a connection member including in one piece therewith a first connection member connected to the headband and a second connection member connected to the arm portion, the first connection member constructing the first connecting section and the second connection member constructing the second connecting section.

5. The headphone according to claim 4, wherein the first connection member has a tubular shape adapted to accommodate therein the biasing element, and the second connection member has a tubular shape adapted to continue and cross to the first connection member, the second connection member being constructed to accommodate therein a shaft to construct the second connecting section.

6. The headphone according to claim 5 further comprising a second holding element constructed to maintain a relative positional relationship between the first connecting section and the arm portion about the second axis.

7. The headphone according to claim 6, wherein the second holding element includes a plurality of fitting counter parts arranged at a peripheral face of the second connection member and spaced from each other; a fitting member operable to be raised and depressed in a direction from the arm portion toward the second connection member and adapted to be fitted with the fitting counter part; and a first biasing member adapted to bias the fitting member toward the second connection member.

8. The headphone according to claim 7 comprising a third connecting section constructed to connect the arm portion to a central portion of the sound emitting portion on a side being opposite to a sound emission side of the sound emitting portion, such that the arm portion is rotatable about a third axis extending along a width direction of the arm portion.

9. The headphone according to claim 8 comprising a third holding element constructed to maintain a relative positional relationship between the sound emitting portion and the arm portion about to the third axis.

10. The headphone according to claim 9, wherein the third connecting section includes an accommodating portion provided at the arm portion, and an accommodating counter portion provided in the sound emitting portion adapted to be accommodated in the accommodating portion such that the accommodating counter portion is rotatable about the third axis and relative to the accommodating portion, and the third holding element includes an inner face of the accommodating portion and an end face of the accommodating counter portion such that the accommodating portion and the accommodating counter portion are brought into engagement with each other, and a second biasing element biasing the end face of the accommodating counter portion toward the inner face of the accommodating portion.

11. The headphone according to claim 10, wherein either of the end face of the accommodating counter portion and the inner face of the accommodating portion includes a convex portion, the other thereof includes a concave portion.

12. The headphone according to claim 11, wherein the convex portion and the concave portion extend straightly.

13. The headphone according to claim 12, wherein the third connecting section includes a plurality of the accommodating counter portions, and the second biasing element of the third holding element is disposed between the plurality of the accommodating counter portions.

14. The headphone according to claim 1 further comprising a second connecting section connecting the arm portion to the first connecting section such that the arm portion is rotatable about a second axis extending in a width direction of the headband being orthogonal to the first axis.

15. The headphone according to claim 14 comprising a connection member including in one piece therewith a first connection member connected to the headband and a second connection member connected to the arm portion, the first connection member constructing the first connecting section and the second connection member constructing the second connecting section.

16. The headphone according to claim 1 comprising a third connecting section constructed to connect the arm portion to a central portion of the sound emitting portion on the side being opposite to a sound emission side of the sound emitting portion, such that the arm portion is rotatable about a third axis extending along a width direction of the arm portion.

17. The headphone according to claim 16 comprising a third holding element constructed to maintain a relative positional relationship between the sound emitting portion unit and the arm portion about the third axis.

18. The headphone according to claim 17, wherein the third connecting section includes an accommodating portion provided at the arm portion, and an accommodating counter portion provided in the sound emitting portion adapted to be accommodated in the accommodating portion such that the accommodating counter portion is rotatable about the third axis and relative to the accommodating portion, and the third holding element includes an inner face of the accommodating portion and an end face of the accommodating counter portion such that the accommodating portion and the accommodating counter portion are brought into engagement with each other, and a second biasing element biasing the end face of the accommodating counter portion toward the inner face of the accommodating portion.

19. The headphone according to claim 14, wherein the second connecting section includes a tubular second connection member attached to the arm portion, and the headphone comprises a holding element maintaining a relative positional relationship between the first connecting section and the arm portion about the second axis, the holding element including: a plurality of fitting counter parts provided in a peripheral face of the second connection member and spaced from each other; a fitting member capable of rising and depressing in a direction from the arm portion toward the second connection member and adapted to be fitted with the fitting counter part; and a biasing member adapted to bias the fitting member toward the second connection member.

20. The headphone according to claim 14, wherein the arm portion includes a notch, the second connecting section includes a tubular second connection member disposed in the notch and attached to the arm portion, and a shaft passing through the arm portion and the second connection member.
